(19) United States
(12) Patent Application Publication
(10) Pub. No.: US 2018/0209190 A1
(43) Pub. Date: Jul. 26, 2018

(54) HINGE AND REFRIGERATOR HAVING THE SAME

(71) Applicants: QINGDAO HAIER JOINT STOCK CO., LTD., Qingdao City, Shandong Province (CN); QINGDAO HAIER SPECIAL REFRIGERATOR CO., LTD., Qingdao City, Shandong Province (CN)

(72) Inventors: HAO ZHANG, Qingdao City, Shandong Province (CN); ENPIN XIA, Qingdao City, Shandong Province (CN); XIAOBING ZHU, Qingdao City, Shandong Province (CN)

(21) Appl. No.: 15/745,110

(22) PCT Filed: Jun. 17, 2016
(86) PCT No.: PCT/CN2016/086161

§ 371 Date: Jan. 15, 2018

(30) Foreign Application Priority Data
Aug. 5, 2015 (CN) 201510474609.7

(51) Int. Cl. E05D 5/14; E05D 3/02; E05D 5/10; E05D 5/12; F25D 23/02

(52) U.S. Cl. CPC E05D 5/14; E05D 3/02; E05D 5/10; E05D 5/12; E05Y 2800/33; E05D 2005/102; E05Y 2900/31; E05Y 2800/28; F25D 23/028

(57) ABSTRACT

The present invention provides a hinge and a refrigerator having the same. The hinge comprises a fixing plate, a supporting plate perpendicularly connected with the fixing plate, and a hinge shaft perpendicularly mounted on the supporting plate to cooperate with a shaft sleeve, wherein the outside of the hinge shaft is plastic-encapsulated with a plastic encapsulating case, the plastic encapsulating case is provided with a protrusion protruding horizontally outwards along the extension direction of the supporting plate, and the protrusion is integrally formed with the plastic encapsulating case.

### TECHNICAL FIELD

The present invention relates to a hinge and a refrigerator having the same.

### BACKGROUND

For a traditional hinge, a hinge plate and a hinge shaft are fitted together by riveting. As there are errors during fitting and the parts themselves also have errors, the perpendicularity between the hinge shaft and the shaft sleeve cannot meet the requirement, and the door using such a hinge cannot be tightly closed or there will be a flash clearance.

Accordingly, the shaft sleeve cooperating with the hinge shaft will radially shake during use due to the fitting clearance between the hinge shaft and the shaft sleeve, or the frictional force between the hinge shaft and the shaft sleeve will be excessive due to an excessive contact area therebetween, which will damage the hinge shaft. In addition, as the hinge used in a refrigerator is always exposed in a humid and cold environment and can be easily corroded, existing solutions for preventing hinge corrosion are usually complex in process or costly.

In view of the above, it is necessary to improve the traditional hinge to solve the above problems.

### SUMMARY

An object of the present invention is to provide a hinge and a refrigerator having the same to solve the problems of an existing refrigerator of corrosion of the hinge shaft, an excessively large fitting clearance between the hinge shaft and the shaft sleeve, and excessive frictional force therebetween.

To realize the above object, the present invention provides a hinge, which comprises a fixing plate, a supporting plate perpendicularly connected with the fixing plate, and a hinge shaft perpendicularly mounted on the supporting plate to cooperate with a shaft sleeve, wherein the outside of the hinge shaft is plastic-encapsulated with a plastic encapsulating case, the plastic encapsulating case is provided with a protrusion protruding horizontally outwards along the extension direction of the supporting plate, and the protrusion is integrally formed with the plastic encapsulating case.

As an improvement of the present invention, two protrusions are arranged on the plastic encapsulating case, and are respectively arranged on the two sides of the supporting plate in the height direction of the hinge shaft.

As another improvement of the present invention, the protrusion protrudes outwards in a ring shape.

As yet another improvement of the present invention, the protrusion comprises an abutting portion to cooperate with the shaft sleeve in an abutting manner and a transition zone connecting the abutting portion and the plastic encapsulating case in an arc shape.

As yet another improvement of the present invention, the supporting plate is provided with a mounting hole for mounting the hinge shaft which is to be inserted into and fixed in the mounting hole.

As yet another improvement of the present invention, the hinge shaft passes through the mounting hole and is fixed on the supporting plate by a rivet.

As yet another improvement of the present invention, the fixing plate is provided with three screw holes.

To realize the above object, the present invention further provides a refrigerator comprising a cabinet, a door and the above hinge.

The present invention has the following advantageous effects. On one hand, the hinge of the present invention is plastic-encapsulated with a plastic encapsulating case on the hinge shaft, which can prevent corrosion of the hinge shaft and enhance the structural strength thereof. On the other hand, a protrusion is provided on the plastic encapsulating case to cooperate with the shaft sleeve, which can reduce the fitting clearance between the hinge shaft and the shaft sleeve, avoid radial shaking of the door and reduce the contact area between the hinge shaft and the shaft sleeve to reduce the frictional force therebetween. Further, the hinge is economical and easy to manufacture.

### BRIEF DESCRIPTION OF THE DRAWINGS

FIG. 1 is a schematic structural view of the present invention.

FIG. 2 is a side view of the hinge of the present invention.

### DETAILED DESCRIPTION

To make the objects, technical solutions and advantages of the present invention clear, the followings will describe the present invention in detail using specific embodiments with reference to the drawings.

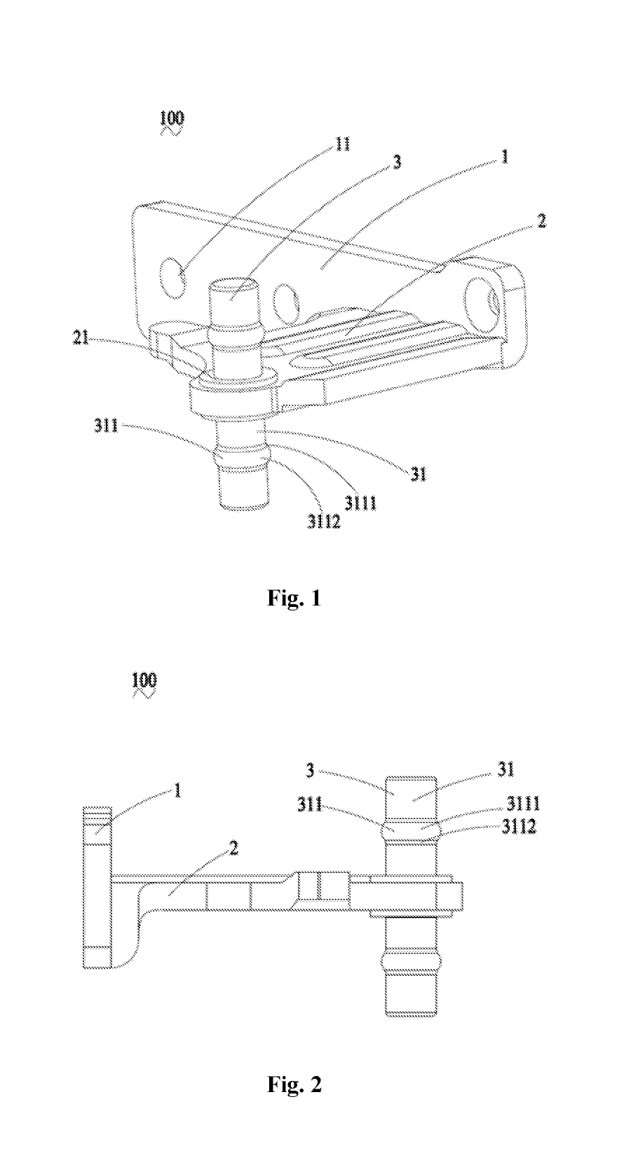

As shown in FIGS. 1 and 2, the refrigerator (not shown in the drawings) of the present invention comprises a cabinet (not shown in the drawings), a door (not shown in the drawings) and a hinge 100 for connecting the cabinet and the door.

The door comprises a shaft sleeve (not shown in the drawings) to cooperate with the hinge 100.

The hinge 100 comprises a fixing plate 1, a supporting plate 2 perpendicularly connected with the fixing plate 1, and a hinge shaft 3 perpendicularly mounted on the supporting plate 2 to cooperate with the shaft sleeve.

The fixing plate 1 is provided with three screw holes 11.

The supporting plate 2 is provided with a mounting hole 21 for mounting the hinge shaft 3 which is to be inserted into and fixed in the mounting hole 21. In the present embodiment, the hinge shaft 3 passes through the mounting hole 21 and is fixed on the supporting plate 2 by a rivet. Of course, the hinge shaft 3 may be fixed on the supporting plate 2 in other manners.

The outside of the hinge shaft 3 is plastic-encapsulated with a plastic encapsulating case 31 which can prevent corrosion of the hinge shaft 3 and increase the structural strength thereof. The thickness at respective parts of the plastic encapsulating case 31 may be adjusted according to the machining errors and surface roughness of the hinge shaft 3 to correct the perpendicularity of the hinge shaft 3, thereby avoiding poor alignment of the door.

The plastic encapsulating case 31 is provided with a protrusion 311 protruding horizontally outwards along the extension direction of the supporting plate 2, and the protrusion 311 is integrally formed with the plastic encapsulating case 31. The protrusion 311 can reduce the contact area between the hinge shaft 3 and the shaft sleeve to reduce the frictional force therebetween, reduce the fitting clearance between the hinge shaft 3 and the shaft sleeve, and avoid radial shaking of the door.

Two protrusions 311 are arranged on the plastic encapsulating case 31, and are respectively arranged on the two sides of the supporting plate 2 in the height direction of the hinge shaft 3. Of course, the protrusions 311 may be arranged only on one side of the supporting plate 2, or two protrusions 311 may be arranged on each side of the supporting plate 2 according to the needs to further reduce radial shaking of the door.

The protrusion 311 protrudes outwards in a ring shape and comprises an abutting portion 3111 to cooperate with the shaft sleeve in an abutting manner and a transition zone 3112 connecting the abutting portion 3111 and the plastic encapsulating case 31 in an arc shape to reduce the cooperation difficulty between the shaft sleeve and the hinge shaft 3. The maximum outer diameter of the abutting portion 3111 is equal to the inner diameter of the shaft sleeve.

According to the hinge 100 of the refrigerator of the present invention, on one hand, the plastic encapsulating case 31 is plastic-encapsulated outside the hinge shaft 3, so that the hinge shaft 3 is isolated from air and corrosion of the hinge shaft 3 can be prevented. On the other hand, the thickness at respective parts of the plastic encapsulating case 31 may be adjusted according to the machining errors and surface roughness of the hinge shaft 3 to correct the perpendicularity of the hinge shaft 3, thereby avoiding poor alignment or flash clearance of the door. Further, as the ring-shaped protrusion 311 is arranged on the plastic encapsulating case 31, the contact area between the hinge shaft 3 and the shaft sleeve is reduced to reduce the frictional force and the fitting clearance therebetween and avoid shaking of the door. Therefore, according to the hinge 100 of the present invention, the above effects can be realized only by plastic-encapsulating the plastic encapsulating case 31 outside the hinge shaft 3. The hinge is simple in structure and economical in cost, and is therefore worthy of being promoted.

The above embodiments are intended to illustrate rather than limit the technical solutions of the present invention. Although the preferable embodiments describe the present invention in detail, those skilled in the art shall understand that modifications or equivalent substitutions may be made to the technical solutions of the present invention without departing from the spirit and scope thereof.

1. A hinge comprising: a fixing plate, a supporting plate perpendicularly connected with the fixing plate, and a hinge shaft perpendicularly mounted on the supporting plate to cooperate with a shaft sleeve, wherein the outside of the hinge shaft is plastic-encapsulated with a plastic encapsulating case, the plastic encapsulating case is provided with a protrusion protruding horizontally outwards along the extension direction of the supporting plate, and the protrusion is integrally formed with the plastic encapsulating case.

2. The hinge according to claim 1, wherein two protrusions are arranged on the plastic encapsulating case, and are respectively arranged on the two sides of the supporting plate in the height direction of the hinge shaft.

3. The hinge according to claim 2, wherein the protrusion protrudes outwards in a ring shape.

4. The hinge according to claim 3, wherein the protrusion comprises an abutting portion to cooperate with the shaft sleeve in an abutting manner and a transition zone connecting the abutting portion and the plastic encapsulating case in an arc shape.

5. The hinge according to claim 1, wherein the supporting plate is provided with a mounting hole for mounting the hinge shaft which is to be inserted into and fixed in the mounting hole.

6. The hinge according to claim 5, wherein the hinge shaft passes through the mounting hole and is fixed on the supporting plate by a rivet.

7. The hinge according to claim 1, wherein the fixing plate is provided with three screw holes.

8. A refrigerator comprising a cabinet, a door and a hinge for connecting the cabinet and the door, the hinge comprises: a fixing plate, a supporting plate perpendicularly connected with the fixing plate, and a hinge shaft perpendicularly mounted on the supporting plate to cooperate with a shaft sleeve, wherein the outside of the hinge shaft is plastic-encapsulated with a plastic encapsulating case, the plastic encapsulating case is provided with a protrusion protruding horizontally outwards along the extension direction of the supporting plate, and the protrusion is integrally formed with the plastic encapsulating case.

9. The refrigerator according to claim 8, wherein two protrusions are arranged on the plastic encapsulating case, and are respectively arranged on the two sides of the supporting plate in the height direction of the hinge shaft.

10. The refrigerator according to claim 9, wherein the protrusion protrudes outwards in a ring shape.

11. The refrigerator according to claim 8, wherein the supporting plate is provided with a mounting hole for mounting the hinge shaft which is to be inserted into and fixed in the mounting hole.

12. The refrigerator according to claim 11, wherein the hinge shaft passes through the mounting hole and is fixed on the supporting plate by a rivet.
